(19) United States
(12) Patent Application Publication
(10) Pub. No.: US 2009/0067034 A1
(43) Pub. Date: Mar. 12, 2009

(54) MEMS STRUCTURE AND OPTICAL MODULATOR HAVING TEMPERATURE COMPENSATION LAYER

(75) Inventors: Ki-Suk Woo, Seoul (KR); Jong-Hyeong Song, Suwon-si (KR); Hee-Yeoun Kim, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 12/060,017

(22) Filed: Mar. 31, 2008

(30) Foreign Application Priority Data
Sep. 7, 2007 (KR) 10-2007-0090975

(51) Int. Cl. G02B 26/00

(52) U.S. Cl. 359/291

(57) ABSTRACT

An optical modulator can be provided that includes a substrate; an insulation layer positioned on the substrate; a ribbon layer such that its center portion is spaced apart from the insulation layer; a piezoelectric actuator positioned on either end of the ribbon layer that provides the driving force which moves the center portion of the ribbon layer vertically; and a temperature compensation layer, which is made of a thermally contracting material having a negative coefficient of expansion, and which is formed on at least one position of an upper portion of the piezoelectric actuator, a lower portion of the piezoelectric actuator, and a lower surface of the ribbon layer corresponding to a position of the piezoelectric actuator. In the optical modulator, the problem of thermal deformation due to rises in temperature can be resolved, whereby the accuracy and reliability of operation of the component can be increased.

### CROSS-REFERENCE TO RELATED APPLICATION

This application claims the benefit of Korean Patent Application No. 10-2007-0090975 filed with the Korean Intellectual Property Office on Sep. 7, 2007, the disclosure of which is incorporated herein by reference in its entirety.

### BACKGROUND

1. Technical Field

The present invention relates to a MEMS component, more particularly to a MEMS structure and optical modulator having a temperature compensation layer, to resolve the problem in a MEMS component including multiple thin film layers of thermal deformation caused by different coefficients of thermal expansion between thin films.

2. Description of the Related Art

MEMS refers to a microelectromechanical system or component, which is a technology that uses semiconductor manufacturing technology to form three-dimensional structures on silicon substrates. There are a variety of applications in which MEMS is used, an example of which is the field of optics. Using MEMS technology allows the manufacture of optical parts smaller than 1 mm, by which micro-optical systems can be implemented. Micro-optical components such as optical modulators and micro-lenses, etc., corresponding to a micro-optical system, are selected for application in telecommunication devices, displays, and recording devices, due to such advantages as quick response time, low level of loss, and convenience in layering and digitalizing.

As an example of a MEMS component, the optical modulator is a circuit or device which loads signals on a beam of light (optical modulation) when the transmission medium is optical fiber or free space in the optical frequency range. Regardless of its operation type, the optical modulator performs the optical modulation by means of diffraction (interference) occurring due to path differences in the reflected incident light. In particular, the piezoelectric type optical modulator generates differences in paths of reflected light using the driving force of piezoelectric actuators, which contract and expand according to a predetermined voltage supplied to the actuators. Thus, in a piezoelectric type optical modulator, the piezoelectric elements play an especially important role in implementing its light diffraction properties.

A MEMS component is generally made of multiple layers of thin film, and because of differences in the coefficients of thermal expansion between the thin films, is inevitably susceptible to problems of thermal deformation. This thermal deformation in the component can be a major cause of changes in operational characteristics of the component, and if left unchecked, does not provide the intended operational characteristics, whereby the accuracy and reliability of the component are greatly degraded. The problem of thermal deformation is especially serious in the bridge-cantilever type of thin film stack structure, such as that illustrated in FIG. 1.

In FIG. 1A, a MEMS structure is illustrated that is composed of a first thin film 10, which is stacked in the form of a bridge, and upper thin films 12 and lower thin films 11 stacked above and below the first thin film 10, respectively. Here, the upper thin films 12 and the lower thin films 11 are formed asymmetrically to each other about the first thin film 10, so that the upper thin films 12 have the form of cantilevers with respect to the lower thin films 11. In such a cantilever structure, deformation inevitably occurs in the first thin film stacked in the form of a bridge because of the thermal expansion of the upper thin films 12, regardless of how great the difference is between the coefficients of expansion of the thin films. This is as illustrated in FIG. 1B.

FIG. 1B shows the thermal deformations of the thin films in a MEMS structure due to a rise in temperature. As illustrated in FIG. 1B, the upper thin films 12 stacked in the form of cantilevers generally expand, due to temperature increases, in a longitudinal direction. Here, the first thin film 10, which is stacked in the form of a bridge to have an empty space in the bottom center, is forced downwards and thus deformed by the longitudinal expansion of the upper thin films 12.

As the problem of thermal deformation caused by changes in temperature is directly related to the accuracy and reliability of operation in a MEMS component having a multi-layered thin film structure, especially a MEMS component having a bridge-cantilever type thin film stack structure, there is a need for a technology that resolves this problem.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

An aspect of the invention is to provide a MEMS structure and optical modulator, in which a temperature compensation layer is added to resolve thermal deformations due to temperature changes, which are caused by differences in the coefficients of thermal expansion between thin films in a MEMS structure formed of multiple layers of thin films.

Another aspect of the invention is to provide a MEMS structure and optical modulator having a temperature compensation layer, in which the problem of thermal deformation is resolved, so that the accuracy and reliability of operation of the component are increased.

One aspect of the invention can provide an optical modulator that includes a substrate; an insulation layer positioned on the substrate; a ribbon layer such that its center portion is spaced apart from the insulation layer; a piezoelectric actuator positioned on either end of the ribbon layer that provides the driving force which moves the center portion of the ribbon layer vertically; and a temperature compensation layer, which is made of a thermally contracting material having a negative coefficient of expansion, and which is formed on at least one position of an upper portion of the piezoelectric actuator, a lower portion of the piezoelectric actuator, and a lower surface of the ribbon layer corresponding to a position of the piezoelectric actuator.

The optical modulator can further include a sacrificial layer positioned between the insulation layer and the ribbon layer that supports the ribbon layer at either end, where the distance between two sacrificial layers positioned at a lower portion of either end of the ribbon layer can be longer than the distance between the piezoelectric actuators positioned at an upper portion of either end of the ribbon layer, so that the piezoelectric actuator may have the form of a cantilever with respect to the sacrificial layer.

Here, the piezoelectric actuator may include a first electrode positioned on the ribbon layer; a second electrode formed to apply a voltage together with the first electrode; and a piezoelectric layer positioned between the first electrode and the second electrode that contracts or expands in correspondence with the voltage applied between the electrodes, to generate a driving force which moves the center portion of the ribbon layer vertically.

Here, there may be at least one hole formed in the center portion of the ribbon layer.

In certain embodiments, the optical modulator may further include reflective layers on parts of the center portion of the ribbon layer where there are no holes formed and on parts of the upper portion of the insulation layer corresponding to parts where there are holes formed.

Any one of zirconium tungstate (ZrW₂O₈), hafnium tungstate (HfW₂O₈), and zirconium hafnium tungstate (Zr_{0.5}Hf_{0.5}W₂O₈) can be used for the thermally contracting material.

Another aspect of the invention can provide a MEMS structure that includes an upper thin film and a lower thin film, which are positioned respectively on an upper portion and a lower portion of a first thin film that has the form of a bridge, and which are formed asymmetrically, such that the upper thin film has the form of a cantilever with respect to the lower thin film, where the MEMS structure further includes a temperature compensation layer, which is made of a material having a coefficient of expansion opposite that of the upper thin film, and which is formed on at least one position of an upper portion of the upper thin film, a lower portion of the upper thin film, and a location between the lower thin film and the first thin film.

Here, the temperature compensation layer can be made of a thermally contracting material having a negative coefficient of expansion.

The thermally contracting material may be any one of zirconium tungstate (ZrW₂O₈), hafnium tungstate (HfW₂O₈), and zirconium hafnium tungstate (Zr_{0.5}Hf_{0.5}W₂O₈).

Of course, in some cases, the temperature compensation layer can be made of a material having a positive coefficient of expansion.

Additional aspects and advantages of the present invention will be set forth in part in the description which follows, and in part will be obvious from the description, or may be learned by practice of the invention.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A and FIG. 1B schematically illustrate thermal deformations due to a rise in temperature in a MEMS structure;

FIG. 2A is a perspective view schematically illustrating a structure of an optical modulator to which an embodiment of the invention can be applied;

FIG. 2B is a perspective view schematically illustrating another structure of an optical modulator to which an embodiment of the invention can be applied;

FIG. 2C illustrates the position of the ribbons when a voltage is not applied to the optical modulator shown in FIG. 2A or FIG. 2B;

FIG. 2D illustrates the position of the ribbons when a voltage is applied to the optical modulator shown in FIG. 2A or FIG. 2B;

FIG. 2E and FIG. 2F are diagrams for describing the optical modulation principles of the optical modulator shown in FIG. 2B;

FIG. 3 is a side-elevational view illustrating an optical modulator according to an embodiment of the invention;

FIG. 4 is a side-elevational view illustrating an optical modulator according to another embodiment of the invention;

FIG. 5 is a graph illustrating the rate of thermal expansion of zirconium tungstate (ZrW₂O₈) as an example of a thermally contracting material applicable to the temperature compensation layer in certain embodiments of the invention;

FIG. 6A illustrates simulation results on the initial deformation state of the ribbons when a temperature compensation layer has not been applied;

FIG. 6B illustrates simulation results on the deformation state of the ribbons according to a rise in temperature when a temperature compensation layer has not been applied;

FIG. 7A illustrates simulation results on the initial deformation state of the ribbons when a temperature compensation layer has been applied; and

FIG. 7B illustrates simulation results on the deformation state of the ribbons according to a rise in temperature when a temperature compensation layer has been applied.

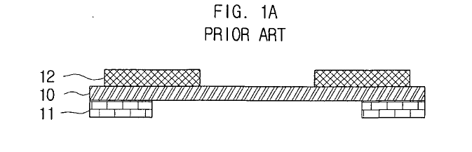

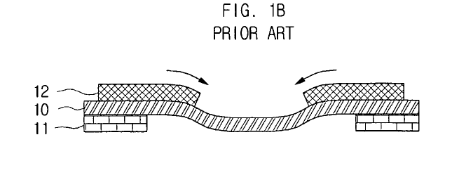

### DETAILED DESCRIPTION

As the present invention allows for various changes and numerous embodiments, particular embodiments will be illustrated in drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first” and “second,” etc., may be used to describe various elements, such elements must not be limited to the above terms. The above terms are used only to distinguish one element from another. For example, a first element may be referred to as a second element without departing from the scope of rights of the present invention, and likewise a second element may be referred to as a first element. The term “and/or” encompasses both combinations of the plurality of related items disclosed and any one item from among the plurality of related items disclosed.

When an element is mentioned to be “formed” or “stacked” on another element, this may mean that it is directly formed on or stacked on the other element, but it is to be understood that another element may exist in-between. On the other hand, when an element is mentioned to be “formed directly” or “stacked directly” on another element, it is to be understood that there are no other elements in-between.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

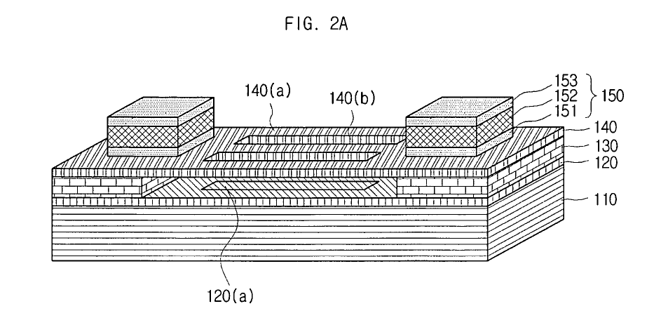

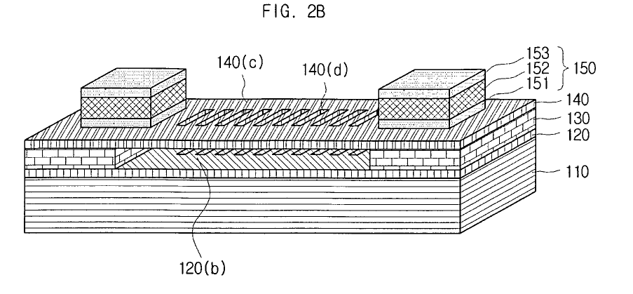

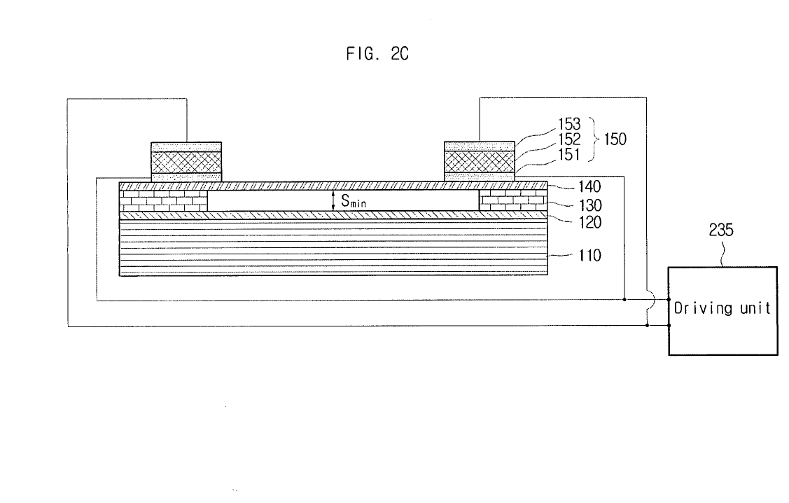

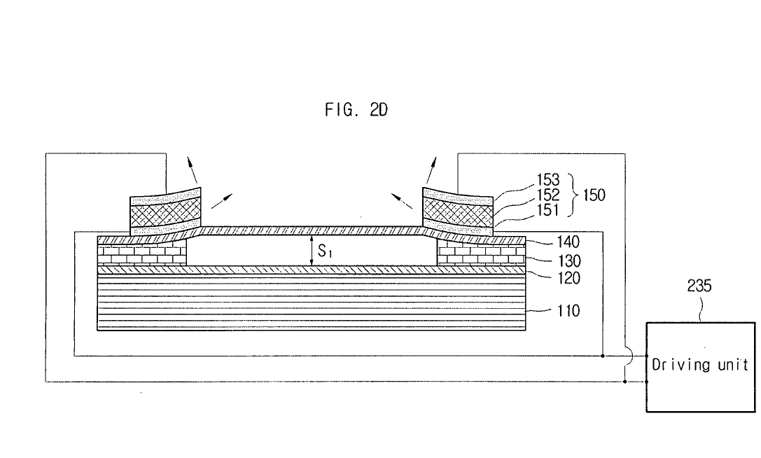

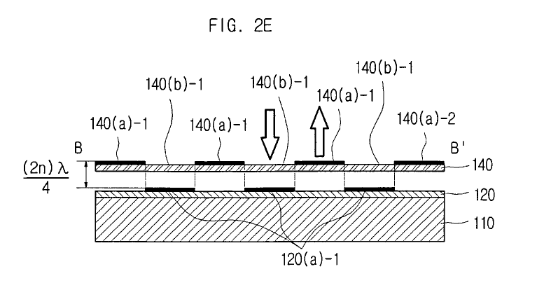

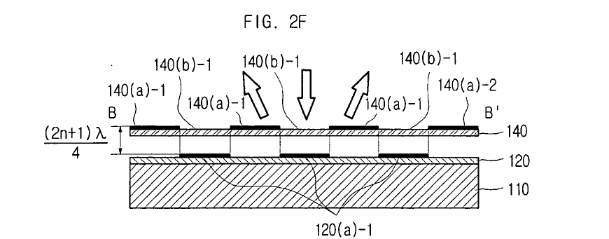

The MEMS structure and optical modulator having a temperature compensation layer according certain embodiments of the invention will be described below in detail with reference to the accompanying drawings. Before describing the embodiments, the structure of an optical modulator, as an example of a MEMS structure to which certain embodiments of the invention can be applied, and the optical modulation principles will first be described with reference to FIGS. 2A through 2F.

FIG. 2A is a perspective view schematically illustrating a structure of an optical modulator to which an embodiment of the invention can be applied, and FIG. 2B is a perspective view schematically illustrating another structure of an optical modulator to which an embodiment of the invention can be applied, while FIGS. 2E and 2F are diagrams for describing the optical modulation principles of the optical modulator shown in FIG. 2B.

Referring to FIGS. 2A and 2B, an optical modulator can include a substrate 110, an insulation layer 120, a sacrificial layer 130, a ribbon layer 140, and piezoelectric actuators 150. Here, the center portion of the ribbon layer 140 (hereinafter referred to as ribbons) can have at least one or more holes (140(b) of FIG. 2A or 140(d) of FIG. 2B). Also, an upper reflective layer (140(a) of FIG. 2A or 140(c) of FIG. 2B) can be formed on parts of the ribbons where there are no holes formed, while a lower reflective layer (120(a) of FIG. 2A or 120(b) of FIG. 2B) can be formed on parts of the insulation layer 120 corresponding to the positions of the holes.

The piezoelectric actuator 150 can supply a driving force that moves the ribbons up and down according to the degree of contraction or expansion of a piezoelectric layer 152 created by a voltage supplied between two electrodes (i.e., a lower electrode 151 and an upper electrode 153). For example, when there is no voltage applied on the piezoelectric actuator 150, the ribbons may maintain their original positions (i.e., the positions of distance Sₘᵢₙ from the insulation layer 120) as illustrated in FIG. 2C, and when a certain voltage is applied, the ribbons may move upward or downward in correspondence to the power applied (see FIG. 2D). By using these position changes of the ribbon as described above, the optical modulator is able to diffract the incident light to generate modulated light (diffracted light). The principles of optical modulation will be discussed below in further detail.

For example, referring to FIG. 2E, in the case where the wavelength of a beam of light incident on the optical modulator is λ, assume that a first voltage is applied between the electrodes that makes the distance between the upper reflective layer 140(a) formed on the ribbons and the lower reflective layer 120(a) formed on the insulation layer 120 substantially equal to (2n)λ/4 (wherein n is a natural number). Here, in the case of a 0-order diffracted (reflected) beam of light, the overall path length difference between the light reflected by the upper reflective layer 140(a) and the light reflected by the lower reflective layer 120(a) is equal to nλ, so that constructive interference occurs, and the diffracted light has its maximum luminance. In the case of +1 or −1 order diffracted light, however, the luminance of the light is at its minimum value due to destructive interference.

Referring to FIG. 2F, assume that a second voltage is applied between the electrodes that makes the distance between the upper reflective layer 140(a) formed on the ribbons and the lower reflective layer 120(a) formed on the insulation layer 120 substantially equal to (2n+1)λ/4 (wherein n is a natural number). Here, in the case of a 0-order diffracted beam of light, the overall path length difference between the light reflected by the upper reflective layer 140(a) and the light reflected by the lower reflective layer 120(a) is equal to (2n+1)λ/2, so that destructive interference occurs, and the diffracted light has its minimum luminance. In the case of +1 or −1 order diffracted light, however, the luminance of the light is at its maximum value due to constructive interference.

As such, the optical modulator can load signals on the beams of light by controlling the quantity of the diffracted light using the results of interference between the beams of light reflected respectively by the upper reflective layer 140(a) and lower reflective layer 120(a), according to the voltage applied between the electrodes.

While the descriptions referring to FIGS. 2E and 2F present only the cases in which the distance is (2n)λ/4 or (2n+1)λ/4 between the ribbons and the insulation layer 120, it is to be appreciated that a voltage of various magnitudes can be applied between the electrodes, with distances that enable the control of the intensity of the diffracted light (i.e., light quantity) interfered by reflection or diffraction. Also, while FIGS. 2A and 2B focus mainly on the optical modulator having holes at the ribbons, it is apparent that embodiments of the invention can be applied without limitation to any type of optical modulator, in which a piezoelectric layer 152 contracts and expands to induce changes in the position of an object of displacement (e.g., the ribbons) in correspondence to a voltage applied between electrodes in order to implement optical diffraction properties, and which generates and outputs diffracted light, by diffracting incident light in correspondence to the displacement induced on the object of displacement.

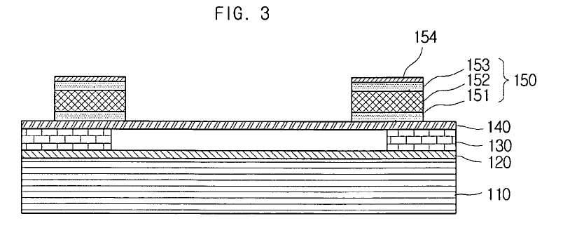

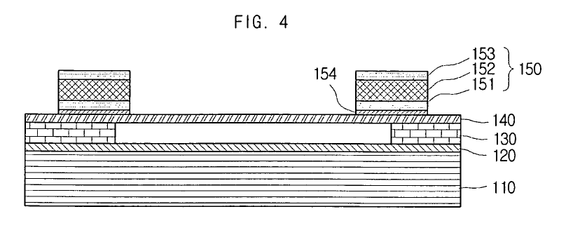

FIG. 3 is a side-elevational view illustrating an optical modulator according to an embodiment of the invention, and FIG. 4 is a side-elevational view illustrating an optical modulator according to another embodiment of the invention.

Referring to FIGS. 3 and 4, the optical modulator can include a substrate 110, an insulation layer 120, sacrificial layers 130, a ribbon layer 140, piezoelectric actuators 150, and a temperature compensation layers 154. Here, a piezoelectric actuator 150 can include a lower electrode 151, a piezoelectric layer 152, and an upper electrode 153.

The substrate 110 may be a typical semiconductor substrate. The substrate 110 can be made from a material such as silicon (Si), alumina (Al₂O₃), zirconia (ZrO₂), quartz, silica (SiO₂), sapphire, aluminum nitride (AlN), etc., where different materials can be used to form the bottom and top surfaces of the substrate 110.

The insulation layer 120 may be positioned on the substrate 110. The insulation layer 120 can act as an etch stop layer, and can be made from a material having a high selectivity to the etchant (where the etchant may be an etchant gas or an etchant solution), which etches the material used for the sacrificial layer 130. For example, the material used for the insulation layer 120 may be silicon oxides (SiO_{X}), etc.

A reflective layer (hereinafter referred to as “lower mirror”), capable of reflecting or diffracting light, can be formed on the insulation layer 120. This lower mirror (not shown) can be formed in correspondence to the positions of the holes formed at the ribbons, and can be made of various reflective materials, for example, metal materials (e.g., Al, Pt, Cr, Ag, etc.).

The sacrificial layer 130 may be positioned on the insulation layer 120. After the sacrificial layer 130 is stacked on the insulation layer 120, a part of the sacrificial layer 130 can be etched so that the sacrificial layer 130 can be positioned on either end of the insulation layer 120 to support the ribbon layer 140.

By thus etching a part of the sacrificial layer 130, the center portion of the ribbon layer 140 (i.e., the ribbons) can be spaced apart from the insulation layer 120, thereby creating a driving space in-between in which the center portion can move up and down. The sacrificial layer 130 may be made from materials such as silicon (Si), amorphous silicon (a-Si), or polycrystalline silicon (poly-Si), etc.

While FIG. 3 and FIG. 4 illustrate an optical modulator having the form of the ribbon layer 140 being supported by parts of the sacrificial layer 130 that have not been removed by the partial etching, it is apparent that the sacrificial layer 130 can be etched in its entirety by the etching process, if the substrate 110 is fabricated to be capable of supporting the ribbon layer 140 at both ends by itself. In such cases, the sacrificial layer 130 does not have to support the ribbon layer 140, and may merely serve to provide a driving space that allows the ribbon layer 140 to move vertically. Thus, the position of the driving space may vary in accordance with the process of etching the sacrificial layer 130 described above. The particular portion of the ribbon layer 140 (in this embodiment, the center portion of the ribbon layer 140) that can move vertically by way of the driving space thus obtained is referred to herein as the ribbons.

The ribbon layer 140 can be positioned on the sacrificial layer 130. The ribbon layer 140 can be formed using a silicon nitride group material (Si_{X}N_{Y}), such as Si₃N₄, etc.

The ribbon layer 140 may be selectively etched to form a particular shape in a certain part (for example, a shape having one or more holes at the ribbons, as in FIGS. 2A and 2B). Here, a reflective layer (hereinafter referred to as “upper mirror”), capable of reflecting or diffracting light, can be formed on the ribbons, for which various reflective materials, for example, metal materials (e.g., Al, Pt, Cr, Ag, etc.), can be used.

The piezoelectric actuators 150 may be positioned at either end on the ribbon layer 140. The piezoelectric actuators 150 enable the ribbons to move downwards or upwards, using the contracting or expanding force of the piezoelectric layer 152 caused by the piezoelectric effect obtained by the voltage applied between the lower electrode 151 and the upper electrode 153. Therefore, a material displaying a piezoelectric quality can be used for the piezoelectric layer 152, for example, a piezoelectric material such as PZT, PNN-PT, PLZT, AlN, ZnO, etc., or a piezoelectric electrolyte material including two or more elements of lead (Pb), zirconium (Zr), zinc (Zn), or titanium (Ti), etc. Furthermore, the lower electrode 151 and the upper electrode 153 can be made from platinum (Pt), nickel (Ni), gold (Au), aluminum (Al), titanium (Ti), IrO₂, RuO₂, etc., but it is apparent that any material which has conductivity and which can thus be utilized as a material for an electrode can be used besides the materials listed above.

Looking at the side elevational views of FIG. 3 and FIG. 4, it can be seen that the optical modulator includes a thin film stack structure coupled in a bridge-cantilever type arrangement. That is, the ribbon layer 140 is supported at both ends by the sacrificial layer 130, so that its center portion (the ribbons) has the form of a bridge suspended in the air. The distance between the sacrificial layers 130 positioned respectively at either end beneath the ribbon layer 140 is longer than the distance between the piezoelectric actuators 150 positioned respectively at either end on top of the ribbon layer 140. Thus, with respect to the sacrificial layers 130 (and excluding the ribbon layer 140 interposed in-between), the piezoelectric actuators 150 have the form of cantilevers that protrude out and are not entirely supported by the sacrificial layers 130.

The problem of thermal deformation due to temperature changes can be more serious in such a thin film stack structure having a bridge-cantilever type arrangement. The reason for this is as follows.

In cases where the upper thin film is entirely supported by the lower thin film, such as in a MEMS structure having a full-surface stacking structure or at least having the lower thin film wider or longer than the upper thin film with respect to the middle thin film, thermal deformation is not significant, even when thermal expansion occurs in the upper thin film due to the rise in temperature of the surrounding environment. This is because in these cases, the MEMS structure is completely supported by the lower thin films to provide a stable arrangement structure, so that the thermal expansion occurring in a certain thin film does not greatly affect the deformation in other thin films. However, in the MEMS structure including the bridge-cantilever type structure described above, the upper thin film is stacked in the form of a cantilever on top of the middle thin film having the form of a bridge, and the thermal expansion in the upper thin film directly affects the middle thin film. The greater the difference in coefficients of thermal expansion between the upper thin film and the middle thin film or between the upper thin film and the lower thin film, the greater the thermal deformation of the middle thin film.

Because of the reason above, the need to resolve the problem of thermal deformation is greater in MEMS structures having the bridge-cantilever structure.

Accordingly, embodiments of the present invention employ a method of additionally stacking a temperature compensation layer, with which the effects of thermal expansion due to temperature changes (especially temperature increases) can be reduced. Most materials generally have a positive coefficient of thermal expansion and expand when the temperature increases. Thus, in embodiments of the invention, the temperature compensation layer can be formed from a thermally contracting material having a negative coefficient of thermal expansion.

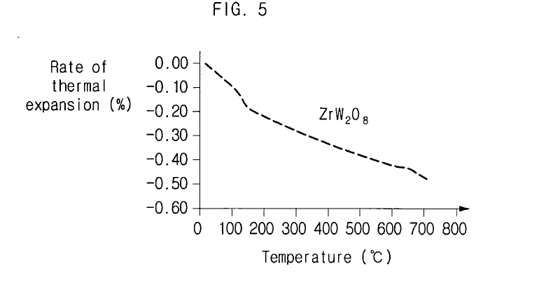

Here, materials such as zirconium tungstate (ZrW₂O₈), hafnium tungstate (HfW₂O₈), zirconium hafnium tungstate (Zr_{0.5}Hf_{0.5}W₂O₈), etc., can be used for the thermally contracting material having a negative coefficient of thermal expansion. FIG. 5 illustrates the rates of thermal expansion (relative values) of zirconium tungstate (ZrW₂O₈), a thermally contracting material applicable to the temperature compensation layer in certain embodiments of the invention. Zirconium tungstate (ZrW₂O₈) is known to have a coefficient of thermal expansion of −10 μm/(m K).

As such, embodiments of the invention employ a method of additionally stacking a temperature compensation layer composed of a thermally contracting material having a negative coefficient of thermal expansion, to greatly relieve the degree to which the thermal expansion in the thin film of the cantilever form affects the thin film of the bridge form.

Accordingly, since the optical modulators of FIG. 3 and FIG. 4 have the ribbon layer 140 in the form of a bridge and the piezoelectric actuators 150 in the form of cantilevers, the temperature compensation layers 154 according to aspects of the invention can be placed at the upper portions or lower portions of the piezoelectric actuators 150, which expand thermally to directly incur problems of deformation in the component. That is, the temperature compensation layer 154 can be formed on the upper surfaces of the piezoelectric actuators 150, as illustrated in FIG. 3, or on the lower surfaces of the piezoelectric actuators 150, as illustrated in FIG. 4.

Of course, the temperature compensation layer 154 can be placed without limitation on any position, besides the positions described above, that provides a lessened degree of thermal deformation. While it is not illustrated in the drawings, the temperature compensation layer 154 can be placed, for example, on the lower surface of the ribbon layer 140 in positions corresponding to the positions of the piezoelectric actuators 150. Obviously, the temperature compensation layer 154 can be placed in two or more of the positions described above. Also, although FIG. 3 and FIG. 4 illustrate an arrangement in which there are no other layers disposed at the upper surfaces and lower surfaces of the piezoelectric actuators 150, if there are passivation layers on the upper surfaces of the piezoelectric actuators 150 for protecting the piezoelectric actuators 150, or if there are junction layers beneath the piezoelectric actuators 150 for better adhesion to the ribbon layer 140, it is apparent that the temperature compensation layer 154 may also be placed on or beneath the passivation layers or junction layers.

However, among the layers that compose the piezoelectric actuator 150, the lower electrode 151 and upper electrode 153 may use metal materials as electrode materials, and since metal materials can have high coefficients of thermal expansion, it can be desirable to place the temperature compensation layer 154 on a position as close as possible to the lower surface of the lower electrode 151 or the upper surface of the upper electrode 153. In certain cases, it can be especially advantageous to stack the temperature compensation layer 154 on the upper electrode 153. This is because thermal expansion can occur more easily in the upper electrode 153, compared to the lower electrode 151 which is in contact with the ribbon layer 140.

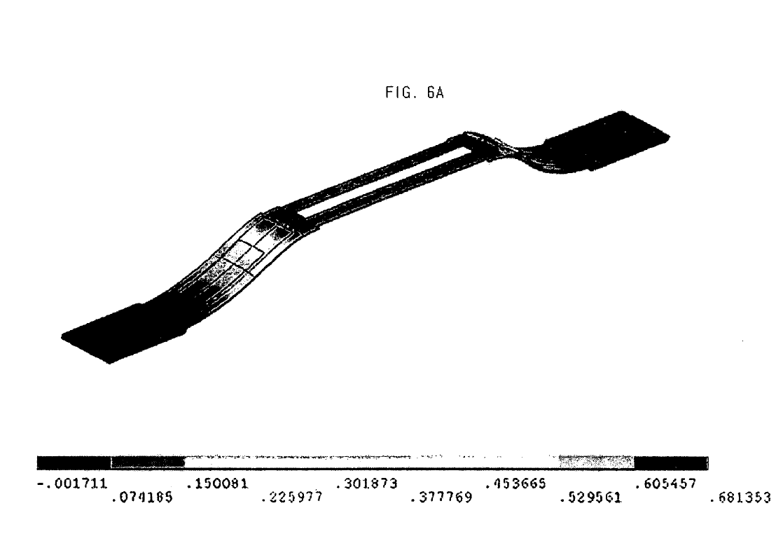

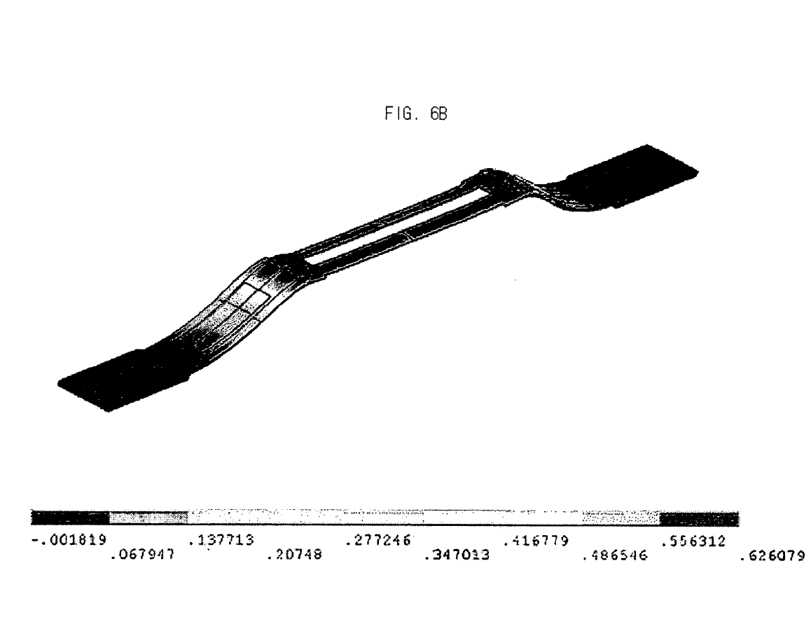

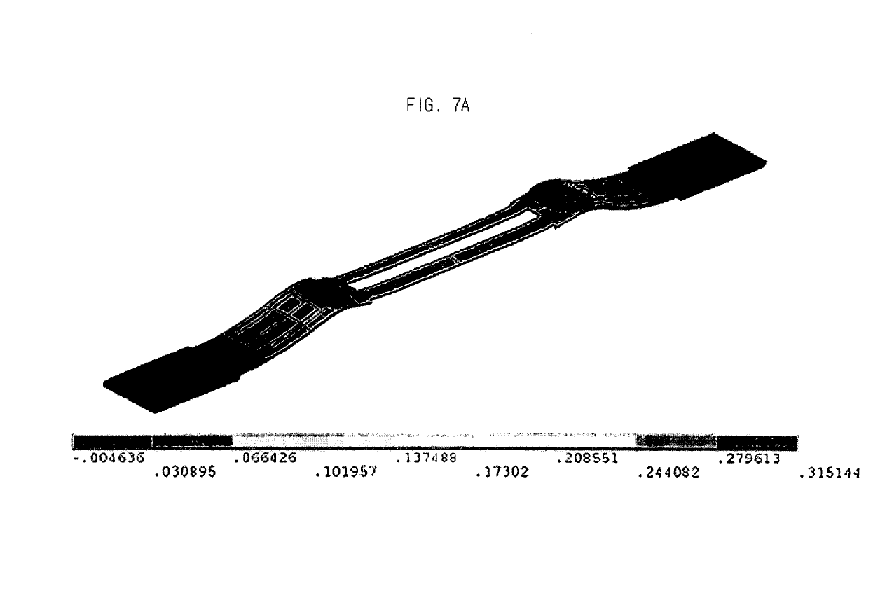

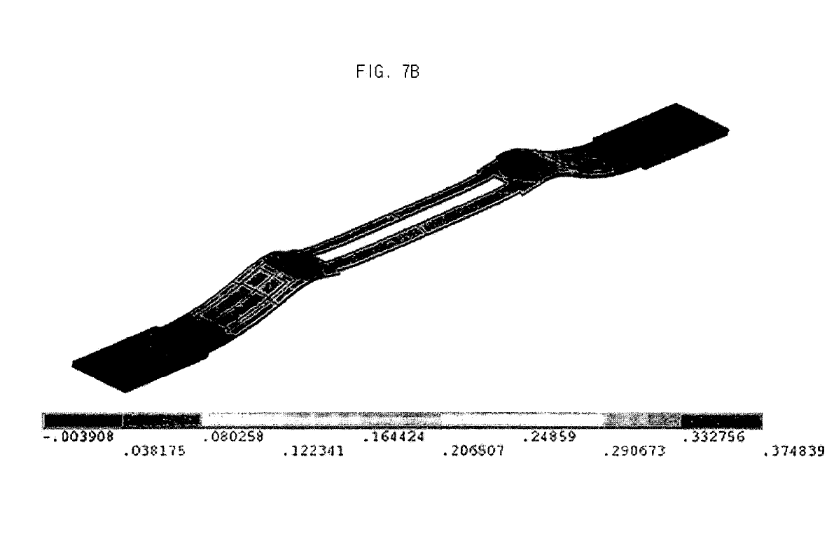

FIG. 6A illustrates simulation results on the initial deformation state of the ribbons when a temperature compensation layer has not been applied, and FIG. 6B illustrates simulation results on the deformation state of the ribbons according to a rise in temperature when a temperature compensation layer has not been applied. FIG. 7A illustrates simulation results on the initial deformation state of the ribbons when a temperature compensation layer has been applied, and FIG. 7B illustrates simulation results on the deformation state of the ribbons according to a rise in temperature when a temperature compensation layer has been applied.

FIG. 6A shows the initial deformation position of the ribbons under a normal temperature condition. In a MEMS structure having a multi-layered thin film structure, the ribbons having a bridge shape may be deformed, with the ribbons somewhat bent by residual stresses from the multiply stacked thin films. FIG. 6B shows the position of the ribbons when the temperature of the surrounding environment has risen to 60° C. Comparing FIGS. 6A and 6B, it is observed that the position of the ribbons dropped from 0.681353 μm under the initial normal temperature condition to 0.626079 μm as the temperature is increased to 60° C. This is because the piezoelectric actuators 150 having the form of cantilevers have thermally expanded according to the rise in the surrounding temperature, and it is easily seen that the ribbons have been thermally deformed in a downward direction.

FIG. 7A shows the initial deformation position of the ribbons under a normal temperature condition when a temperature compensation layer 154 made of a thermally contracting material having a negative coefficient of thermal expansion has been added according to an embodiment of the invention. In FIG. 7A, the initial deformation position of the ribbons is read to be 0.315114 μm. This is because although the case shown in FIG. 7A is under the same normal temperature condition as is the case shown in FIG. 6A, additionally stacking the temperature compensation layer 154 according to an embodiment of the invention has resulted in residual stresses of the thin films different from the case shown in FIG. 6A. FIG. 7B shows the position of the ribbons when the temperature of the surrounding environment has risen to 60° C. Looking at FIG. 7B, it is observed that the position of the ribbons is at 0.374839 μm, which is higher than the position in FIG. 7A. This reveals that additionally stacking the temperature compensation layer 154 has provided a countermeasure against the thermal expansion of the piezoelectric actuators 150.

Of course, an aim of the present invention is to relieve (compensate for) the problem of thermal deformation caused by thermal expansion by way of the temperature compensation layer 154. Therefore, having the amount of compensation greater than the amount of thermal deformation so that the ribbons are raised from their initial deformation position, as is the case in FIG. 7B, may not be desirable. However, it is to be clearly understood that the amount of compensation can be controlled by adequately adjusting the thickness and other conditions of the temperature compensation layer 154 added, and that the purpose of the simulation results shown in FIG. 7B is to verify the technical principle that the thermal deformation can be compensated and countered in the opposite direction by additionally stacking a temperature compensation layer 154.

As described above, in embodiments of the invention, thermal deformations due to temperature changes in a MEMS structure formed from multiple layers of thin films can be resolved using a method of additionally stacking a temperature compensation layer, whereby the accuracy and reliability of operation can be increased.

While the above descriptions concentrated on optical modulators that include a thin film stack structure of a bridge-cantilever type arrangement, it will be readily appreciated by those skilled in the art that the principles of the invention can be applied directly to any MEMS structure having a bridge-cantilever type structure.

Furthermore, while the above descriptions concentrated mainly on those cases where the temperature compensation layer is made using a thermally contracting material having a negative coefficient of thermal expansion, it is apparent the case of having the temperature compensation layer formed using a material having a coefficient of thermal expansion opposite that of the upper thin film having the form of a cantilever, in a MEMS structure having a bridge-cantilever structure, can easily be inferred from the principles of the present invention.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

While illustrative embodiments have been illustrated and described, it will be appreciated that various changes can be made therein without departing from the spirit and scope of the invention.

The embodiments of the invention in which an exclusive property or privilege is claimed are defined as follows:

1. An optical modulator comprising:
a substrate;
an insulation layer positioned on the substrate;
a ribbon layer positioned with a center portion thereof spaced apart from the insulation layer;
a piezoelectric actuator positioned on either end of the ribbon layer and configured to provide a driving force such that moves the center portion of the ribbon layer vertically; and
a temperature compensation layer made of a thermally contracting material having a negative coefficient of expansion and formed on at least one position of an upper portion of the piezoelectric actuator, a lower portion of the piezoelectric actuator, and a lower surface of the ribbon layer corresponding to a position of the piezoelectric actuator.

2. The optical modulator of claim 1, further comprising a sacrificial layer positioned between the insulation layer and the ribbon layer and supporting the ribbon layer at either end,
wherein a distance between the sacrificial layers positioned at a lower portion of either end of the ribbon layer is longer than a distance between the piezoelectric actuators positioned at an upper portion of either end of the ribbon layer, such that the piezoelectric actuator has the form of a cantilever with respect to the sacrificial layer.

3. The optical modulator of claim 1, wherein the piezoelectric actuator comprises:
a first electrode positioned on the ribbon layer;
a second electrode formed to apply a voltage together with the first electrode; and
a piezoelectric layer positioned between the first electrode and the second electrode and configured to contract or expand in correspondence with the voltage applied between the electrodes to generate a driving force such that moves the center portion of the ribbon layer vertically.

4. The optical modulator of claim 1, wherein at least one hole is formed in the center portion of the ribbon layer.

5. The optical modulator of claim 4, further comprising reflective layers on a part of the center portion of the ribbon layer where the hole is not formed and on a part of an upper portion of the insulation layer corresponding to a part where the hole is formed.

6. The optical modulator of claim 1, wherein the thermally contracting material includes any one of zirconium tungstate (ZrW₂O₈), hafnium tungstate (HfW₂O₈), and zirconium hafnium tungstate (Zr_{0.5}Hf_{0.5}W₂O₈).

7. A MEMS structure comprising an upper thin film and a lower thin film positioned respectively on an upper portion and a lower portion of a first thin film having the form of a bridge and formed asymmetrically such that the upper thin film has the form of a cantilever with respect to the lower thin film, the MEMS structure further comprising:
a temperature compensation layer made of a material having a coefficient of expansion opposite that of the upper thin film and formed on at least one position of an upper portion of the upper thin film, a lower portion of the upper thin film, and a location between the lower thin film and the first thin film.

8. The MEMS structure of claim 7, wherein the temperature compensation layer is made of a thermally contracting material having a negative coefficient of expansion.

9. The MEMS structure of claim 8, wherein the thermally contracting material includes any one of zirconium tungstate (ZrW₂O₈), hafnium tungstate (HfW₂O₈), and zirconium hafnium tungstate (Zr_{0.5}Hf_{0.5}W₂O₈).

10. The MEMS structure of claim 7, wherein the temperature compensation layer is made of a material having a positive coefficient of expansion.
